(19) United States
(12) Patent Application Publication
(10) Pub. No.: US 2014/0166116 A1
(43) Pub. Date: Jun. 19, 2014

(54) CHARGING DEVICE FOR SHAFT FURNACE WITH CONTROLLER FOR CLEAN GAS FED TO ITS MAIN CASING

(71) Applicants: Paul Tockert, Berbourg (LU); Emile Lonardi, Bascharage (LU); Lutwin Franziskus, Wochern (DE); Guy Thillen, Diekirch (LU); Gérald Hubeaux, Luxembourg (LU)

(72) Inventors: Paul Tockert, Berbourg (LU); Emile Lonardi, Bascharage (LU); Lutwin Franziskus, Wochern (DE); Guy Thillen, Diekirch (LU); Gérald Hubeaux, Luxembourg (LU)

(73) Assignee: PAUL WURTH S.A., Luxembourg (LU)

(21) Appl. No.: 14/233,845

(22) PCT Filed: Jul. 19, 2012
(86) PCT No.: PCT/EP2012/064137

§ 371 Date: Jan. 29, 2014

(30) Foreign Application Priority Data
Jul. 22, 2011 (LU) 91 844

(51) Int. Cl. F27B 1/20; F27D 3/06

(52) U.S. Cl. CPC F27B 1/20; F27D 3/06
USPC 137/14; 137/82

(57) ABSTRACT

A charging device for a shaft furnace comprises a main casing and at least one nozzle for introducing a clean gas into the casing. According to an important aspect of the invention, a controller is configured to adapt the supply (the flow rate) or pressure of clean gas in the main casing based on charging status information.

### FIELD OF THE INVENTION

The present invention generally relates to charging installations for shaft furnaces and in particular to a device for distributing charge material in the furnace. More specifically, the invention relates to the type of device that is equipped with a chute for circumferential and radial distribution of the charge material.

### BACKGROUND OF THE INVENTION

As it is well known in the art, the charging of a blast furnace is conventionally carried out by means of a top charging installation, which serves the function of storing raw materials on the furnace top and distributing these materials into the furnace. Raw materials are weighed in the stockhouse and delivered in a batch mode (via skip car or conveyor belt) to the furnace top charging installation, where they are stored in intermediate hoppers.

For distributing the charge material (burden) into the furnace, the top charging installation preferably comprises a rotary charging device arranged on the furnace throat and below the intermediate hoppers. The rotary distribution device comprises a stationary housing and a suspension rotor with a charge distributor, the suspension rotor being supported in the stationary housing so that it can rotate about the furnace axis. The suspension rotor and stationary housing form the main casing of the rotary charging device, in which mechanisms for driving the suspension rotor and pivoting the charge distributor are arranged.

Such rotary distribution device is e.g. known from U.S. Pat. No. 3,693,812.

As it is also known in the art, whilst the stationary housing and suspension rotor cooperate to form a closed casing, the rotary mounting of the suspension rotor and the operational play between the moving (suspension rotor) and stationary (housing) parts requires an annular gap through which furnace gases may enter the main casing.

In order to prevent the entrance of furnace gas, heavily loaded with dust, into the main casing of the rotary distribution device, it is known to fill the casing with nitrogen. For an efficient result, the nitrogen flow should be high enough to maintain the pressure level in the main casing above the pressure in the furnace interior.

U.S. Pat. No. 6,540,958, for example, describes the use of a slight nitrogen over-pressure in the main casing of the rotary distribution device, and suggests that this may be carried out automatically. As will be appreciated by those skilled in the art, an automatic control of the nitrogen pressure in the casing may be carried out in closed loop by means of a pressure sensor installed in the furnace throat.

GB 1 526 478 discloses a blast furnace with a rotary charging device, in which cleaned and cooled throat gas is introduced in order to cool the driving mechanism of the distribution chute and establish a positive pressure differential to prevent the entry of dust. The conditioning of the top gas is achieved in a system comprising a “mini-venturi” and a compression stage featuring a main compressor and auxiliary compressor. The system is set so that the mini-venturi is automatically set to predetermined positions so that the pressure and degree of purification of the gas is constant.

### OBJECT OF THE INVENTION

The object of the present invention is to provide an alternative way of regulating the gas pressure in the main casing of a charging device.

### SUMMARY OF THE INVENTION

The present inventors have found that the gas flow rate required to prevent the entrance of dust-laden furnace gas into the main casing of the distribution device is greater during charging phases than when no material is introduced into the furnace. The inventors have further observed that the suitable gas flow rate into the casing of the charging device is dependent on the type of raw material being charged into the furnace through the charging device.

Accordingly, the present invention concerns a charging device for a shaft furnace comprising:

a main casing, e.g. provided for accommodating therein the drive mechanism of the distribution chute of the charging device and surrounding a feed channel,

a movable distribution chute for distributing charge material falling therein through said feed channel, the distribution chute being preferably pivotable and/or rotatable; and

at least one nozzle for introducing in the casing a clean gas (e.g. cleaned blast furnace gas), preferably an inert gas, more preferably nitrogen (N₂). As used herein, the term “clean gas” designates a gas that is essentially free of dust particles, i.e. containing less than 20 mg/Nm³, preferably less than 10 mg/Nm³, of dust (1 Nm³ =1 m³ in standard conditions: at 0% humidity, 1,02325 bar and 0° C.).

According to an important aspect of the invention, a controller is configured to adapt the supply (the flow rate) or pressure of clean gas in the main casing based on charging status information.

The charging device may be of any type. For instance, it could comprise a distribution chute suspended on gimbals, as described, for instance, in EP 1 662 009. However, according to a more preferred embodiment of the invention, the charging device is a rotary charging device, comprising

a stationary housing for mounting on the throat of the shaft furnace, the stationary housing having a feed channel with an inlet section and an outlet section through which charge material flows towards the shaft furnace;

a suspension rotor with a charge distributor, the suspension rotor being supported in the stationary housing so that it can rotate about an axis; and

wherein the suspension rotor and stationary housing cooperate to form the main casing of the rotary charging device, in which mechanisms for assisting in rotating and pivoting said charge distributor may typically be arranged.

The present system takes into account information reflecting a charging status to set the level of clean gas, and does not require a permanent pressure measurement of the furnace gas. As explained above, the present inventors have observed that different clean gas flow rates may be employed depending on whether the furnace is being charged or not, and also depending on the type of raw material being charged into the furnace. In particular, a comparatively lower clean gas flow rate is required to prevent dust-laden furnace gas from entering into the main casing when no material is being charged. Conversely, the supply/pressure of clean gas is typically to be increased when raw material is introduced into the furnace.

The term “charging status information” is thus to be understood as encompassing any information reflecting the charging status of the device, respectively of the furnace. Charging status information may namely indicate that: the charging device is currently (is to be) operated to charge the furnace; or that charge material is currently flowing through the charging device to the furnace; or that no charging is taking place.

Charging status information may advantageously include information identifying the type of charge material, which is then used as a further parameter to set the desired level of supply or pressure of clean gas.

In practice, the implementation of the present invention may involve a calibration of the level of supply or pressure of clean gas that is appropriate for each charging status. A corresponding map of clean gas supply/pressure vs. operating status may then be stored in the controller.

As it will further be understood by those skilled in the art, the charging status information may be readily derived from the charging program of the shaft furnace. Such charging program conventionally defines the batch-wise charging procedure of the shaft furnace, and inter alia the types and amounts of raw materials, their order of supply to the blast furnace interior. The controller is thus preferably configured to receive from the charging program controller relevant charging information reflecting the current charging status.

Hence the present invention provides an open-loop control of the clean gas supply, in particular nitrogen, into the main casing of the distribution device. The proposed control scheme advantageously comprises adapting the clean gas flow rate within the main casing on basis of charging program information, readily available in the blast furnace's control system.

As compared to a closed loop control with a pressure sensor, the present invention proposes a simpler and more stable way of controlling the clean gas pressure in the main casing. It can be operated, upon calibration, on the basis of information readily available in the blast furnace control system. It does not require a high-precision differential pressure sensor (charging system main casing pressure/blast furnace pressure), the reliability of which is challenged by the severe conditions within the furnace.

As compared to a basic nitrogen filling, where a single nitrogen flow rate is set irrespective of the operation of the furnace, the savings on nitrogen are substantial.

### BRIEF DESCRIPTION OF THE DRAWING

The present invention will now be described, by way of example, with reference to the accompanying drawing, in which:

FIG. 1: is a principle vertical cross-section view through a rotary distribution device for shaft furnace.

### DETAILED DESCRIPTION OF A PREFERRED EMBODIMENT

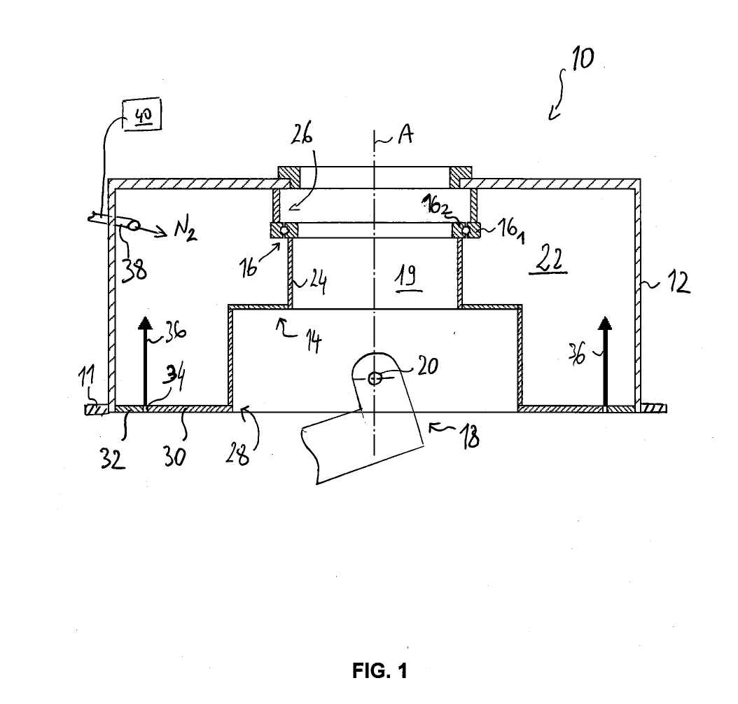

FIG. 1 is a shows the main elements of a rotary distribution device 10 for distributing bulk charge material (“burden”) into a shaft furnace, especially onto the stock-line of a blast furnace (not shown). As it is known in the art, the device 10 is designed to be part of a top charging installation (not shown).

Typically, the distribution device 10 is arranged to close the top opening of the reactor, e.g. on the throat of the furnace. The distribution device 10 is fed with charge material from one or more intermediate storage hoppers (not shown), e.g. according to a configuration as disclosed in WO 2007/082633.

The distribution device 10 has a stationary housing 12 with a ring-shaped circumferential mounting flange 11 at its lower, outer circumference by means of which the casing 12 is typically fixed, in a leak-proof manner, e.g. to the brim (not shown) of the furnace throat opening. Inside the casing 12, a suspension rotor, generally identified at 14, is supported by means of a large-diameter annular roller bearing 16 (e.g. slewing bearing) on the stationary housing 12. The rotor 14 is thus rotatable about a substantially vertical rotation axis A that corresponds e.g. to the blast furnace axis. As seen in the FIGURE, a distribution chute, generally identified at 18, is mounted to the suspension rotor 14 so as to rotate in unison therewith about axis A. The chute 18 actually comprises a pair of lateral suspension arms 20 by means of which it is suspended on the suspension rotor 14 and that further allow its tilting about a horizontal axis. Hence, chute 18 is rotatable about axis B and pivotable about axis A.

In the present variant, the rotor 14 defines the central feed channel 19 of the device 10, through which charge material flows from the above storage hoppers to the distribution chute 18. In other instances, a feed spout defining a narrower feed channel can be arranged inside rotor 14.

As it will be understood, the suspension rotor 14 and the stationary housing 12 cooperate to form the main casing 22 of the rotary charging device and hence define a substantially closed annular chamber. The main casing 22 thus surrounds feed channel 19.

Conventionally, a part of the mechanisms (not shown) required to rotate the rotor 14 about axis A and tilt the chute about the horizontal axis are arranged within the main casing 22. The configuration of the mechanisms for rotating and tilting the chute 18 is known in the art and is not the focus of the present invention, and so will not be further described herein. For more details about such mechanisms, one may refer e.g. to US 2003/0180129. Also conventionally installed inside the main casing 22 is a cooling arrangement to avoid damage and, especially but not exclusively, for protecting the mechanism components required for operating the rotor 14 and chute 18.

It may be noted that the rotor 14 comprises a tubular support or body 24 that is arranged coaxial with the rotation axis A and that carries the chute 18. The tubular body 24 extends vertically from an inlet section 26 of the stationary housing 12 (also entry of the feed channel 19), where an external race 16₁ of the roller bearing 16 is fixed, down to an outlet section 28 at the lower end of the housing 12 (outlet of feed channel 19). The interior race 16₂ of roller bearing 18 is then fixed at the upper rim of the body 24. In this exemplary variant, the rotor body 24 has a stepped profile broadening towards the furnace and ending with an annular horizontal flange 30 that also forms a screen between the interior of the main casing 22 and the interior of the furnace.

The flange 30 of the suspension rotor 14 extends laterally (radially) in close proximity of a mating horizontal, peripheral flange 32 of the stationary housing 12. The respective dimensions of the rotor flange 30 and housing flange 32 are designed to maintain an, as small as possible, annular gap 34 that forms an operational play allowing rotation of the rotor 14.

Due to this operational play furnace gas may enter the main casing 22—as represented by arrows 36—and substantial amounts of dust and particles may deposit therein and hinder the operation of the gears and other mechanisms installed therein. Another critical area for the flow of furnace gas into the main casing 22 is at the level of bearing 16. To minimize entrance of furnace gas into the main casing 22, clean gas, preferably nitrogen, is introduced into the main casing, e.g. via one or more nozzles 38, and a clean gas pressure at least slightly superior to the gas pressure inside the furnace is maintained.

It shall be appreciated that in the present device, the clean gas flow rate inside the main casing 22 is controlled by a controller 40 on the basis of information reflecting a charging status of the device 10 or furnace.

As explained above, the present inventors have observed that different clean gas flow rates may be employed depending on whether the furnace is being charged or not, and also depending on the type of raw material being charged into the furnace. In particular, a comparatively lower clean gas flow rate is required to prevent furnace gas entry into the main casing 22 when no material is being charged. Conversely, the flow rate of clean gas is typically to be increased when raw material is introduced into the furnace.

The charging status is readily derivable from the charging program conventionally used in the blast furnace control system. The controller 40 may thus be in communication with the blast furnace control system, and preferably integrated therein.

The clean gas flow rate required to prevent entrance of furnace gas when charging iron-bearing materials is greater than the required clean gas flow rate when charging with coke. The lowest clean gas flow rate is when the charging device 10 is at rest and no charge material is being introduced.

Although not willing to be bound by theory, it is believed that the amplitude of pressure variation between the various charge materials depends on their respective apparent density and void index. The more compact the volume of raw material (minimal void between the particles of the bulk material), the greater the displacement of gas streams and the higher the gas furnace pressure in the vicinity of rotary distribution device 10.

In practice, the appropriate clean gas flow rate to prevent entrance of furnace gas into the main casing 22 can be determined by calibration.

A map, as e.g. shown in table 1, of clean gas pressure or flow rate vs. charging status can thus be stored in the controller, which will then adapt the clean gas supply in function of charging status. As it will be understood from the above explanations: L1<L2<L3.

TABLE 1

| Charging status | Clean gas pressure or flow rate |
|---|---|
| 1 - no charging | L1 |
| 2 - charging/coke | L2 |
| 3 - charging/ferrous burden | L3 |

Although the present invention has been described with respect to a particular embodiment of stationary housing and internal rotor, it is however clear that the proposed clean gas regulation can be implemented with a variety of designs of the rotary distribution device, and thus of the main casing.

1-15. (canceled)

16. A charging device for a shaft furnace comprising:
a main casing surrounding a feed channel;
a movable distribution chute for distributing charge material falling therein through said feed channel; and
at least one nozzle for introducing a clean gas into said main casing;
a controller that is configured to adapt the supply or pressure of clean gas in said main casing depending on charging status information.

17. The charging device according to claim 16, wherein said charging status information is indicative of whether charge material is currently charged in the furnace, or not.

18. The charging device according to claim 17, wherein said charging status information is indicative of the type of charge material.

19. The charging device according to claim 16, wherein said charging status information is indicative of the type of charge material.

20. The charging device according to claim 16, wherein said charging status information is determined from a blast furnace charging program.

21. The charging device according to claim 20, wherein said controller comprises a map prescribing a pre-determined pressure or flow level of clean gas for each phase of blast furnace charging program.

22. The charging device according to claim 21, wherein for each phase of blast furnace charging program the pre-determined pressure or flow level has been calibrated to maintain a clean gas pressure in said main casing superior to the furnace gas pressure in the vicinity of the charging device.

23. The charging device according to claim 21, wherein in case no material is charged in said blast furnace, said controller operates a predetermined pressure or flow level, lower than that used during a charging phase.

24. The charging device according to claim 16, wherein in case no material is charged in said blast furnace, said controller operates a predetermined pressure or flow level, lower than that used during a charging phase.

25. The charging device according to claim 16, wherein said clean gas is nitrogen.

26. The charging device as claimed in claim 16, wherein said charging device is a rotary charging device comprising:
a stationary housing for mounting on the throat of the shaft furnace;
a suspension rotor with a charge distributor, said suspension rotor being supported in said stationary housing so that it can rotate about an axis;
wherein said suspension rotor and said stationary housing cooperate to form said main casing of said rotary charging device.

27. A top charging installation for a shaft furnace, in particular a blast furnace, comprising a charging device according to claim 16.

28. A method for operating a charging device of a shaft furnace comprising a main casing; wherein clean gas is supplied to said main casing to prevent the flow of furnace gas therein;
wherein the supply or pressure of clean gas is adapted by a controller depending on charging status information.

29. The method according to claim 28, wherein said charging status information is determined from a blast furnace charging program.

30. The method according to claim 29, wherein said controller comprises a map prescribing a pre-determined pressure or flow level of clean gas for each phase of blast furnace charging program.

31. The method according to claim 30, wherein for each phase of blast furnace charging program the pre-determined pressure or flow level has been calibrated to maintain a clean gas pressure in said main casing superior to the furnace gas pressure in the vicinity of the charging device.

32. The method according to claim 28, wherein said charging status information is indicative of whether charge material is currently charged in the furnace, or not.

33. The method according to claim 32, wherein said charging status information is indicative of the type of charge material.

34. The method according to claim 28, wherein in case no material is charged in said blast furnace, said controller operates a predetermined pressure or flow level, lower than that used during a charging phase.

35. The method according to claim 28, wherein said charging device comprises a stationary housing and a suspension rotor with a charge distributor, said suspension rotor being supported in said stationary housing so that it can rotate about an axis; said suspension rotor and said stationary housing cooperating to form said main casing of said charging device.

36. A controller for a charging device of a shaft furnace, wherein said controller is configured to receive charging status information and generate a clean gas pressure control signal depending on said charging status information.

37. HA computer program comprising computer program code means adapted to perform the method according to claim 28 when said program is run on a computer.
